(19) United States
(12) Patent Application Publication
(10) Pub. No.: US 2026/0087380 A1
(43) Pub. Date: Mar. 26, 2026

(54) BUILDING A DATASET HAVING REQUISITE NUMBER OF FRAUD SAMPLES TO TRAIN A MULTI-CLASS MACHINE LEARNING MODEL FOR FRAUD DETECTION

(71) Applicant: Oracle Financial Services Software Limited, Mumbai (IN)

(72) Inventor: Mridul Kumar Nath, Bangalore (IN)

(21) Appl. No.: 18/897,008

(22) Filed: Sep. 26, 2024

(51) Int. Cl. G06N 5/022

(52) U.S. Cl. CPC G06N 5/022

(57) ABSTRACT

According to an aspect, a system receives a historical data and identifies a set of transactions tagged as fraud (“fraud transactions”) in the received data. If a count of fraud transactions is below a threshold, the system forms a training data and a test data from the historical data, with the test data including all the fraud transactions. The system generates, based on the training data, a one-class anomaly detection model that is able to flag all the fraud transactions when the test data is provided as input to the model. The system applies the model to an inference data to identify whether each transaction therein is an anomaly or not. Upon receiving an input data indicating whether each anomaly is a fraud transaction or not, the system updates the historical data by adding the transactions and tagging the fraud transactions. The updated historical data is used for training a multi-class ML model after the count of fraud transactions is greater than or equal to the threshold.

### BACKGROUND OF THE DISCLOSURE

### Technical Field

The present disclosure relates to computing systems, and more particularly to building a dataset having requisite number of fraud samples to train a multi-class machine learning model for fraud detection.

### Related Art

Fraud detection refers to determination of whether computer implemented transactions performed by users are legitimate or fraudulent. Fraud detection is an important aspect of risk management, particularly in sectors such as banking and insurance.

Machine Learning (ML) models are often used for such fraud detection. As is well known, a ML model is typically trained based on historical set of transactions to thereafter predict whether a given transaction of inference data is possibly fraudulent or not.

For reliable detection of fraud transaction, it is generally understood that ML Models are required to be based on multi-class ML techniques, with the multi-class ML model being designed to classify each transaction into multiple classes (i.e., the target attribute having at least two classes). Such multi-class ML model used for fraud detection is hereafter referred to as fraud detection model.

As is well known, the historical set used to train a fraud detection model must generally have a reasonable number of transactions containing both normal and fraud samples. Factors such as the data model chosen and degree of precision required, may accordingly determine the requisite number/type of samples needed for building a robust fraud detection model.

However, at the inception of deployment of fraud detection using multi-class ML models, the number of fraud samples may not match the requisite number. Accordingly, the deployment of a multi-class ML model may need to be delayed until such requisite number of fraud samples are available.

Aspects of the present disclosure are directed to building a dataset having such requisite number of fraud samples for training a multi-class fraud detection model.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which a dataset having requisite number of fraud samples to train a multi-class machine learning model for fraud detection is built according to aspects of the present disclosure.

FIG. 3 depicts the manner in in which historical data is maintained in one embodiment.

FIG. 4 is a block diagram of a dataset builder according to several aspects of the present disclosure.

FIG. 5 illustrates a user interface provided for manual investigation of suspected anomalous transactions in one embodiment.

FIG. 6 illustrates a process flow of several aspects of the present disclosure in one embodiment.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE 1. Overview

The present disclosure relates generally to using artificial intelligence techniques to aid fraud detection. More specifically and without limitation, techniques disclosed herein relate to a novel approach performed to build a dataset having requisite number of fraud samples to train a multi-class machine learning (ML) model for fraud detection.

According to an aspect of the present disclosure, a digital processing system receives a historical data (at a specific time instance) and identifies a set of transactions tagged as fraud (hereinafter “fraud transactions”) in the received historical data. If a count of the fraud transactions is below a threshold, the system forms a training data and a test data from the historical data, with the test data including (all of) the fraud transactions. The system generates, based on the training data, a one-class (anomaly detection) ML model that is able to predict (flag all) the fraud transactions when the test data is provided as input to the one-class ML model. The system applies the one-class ML model to a set of transactions of an inference data to identify whether each transaction is an anomaly or not. Upon receiving an input data indicating whether each transaction identified as the anomaly is a fraud transaction or not, the system updates the historical data by adding the set of transactions and tagging each fraud transaction as being fraud to form an updated historical data. The updated historical data is used for training a multi-class ML model after the count of the fraud transactions is greater than or equal to the threshold.

According to another aspect of the present disclosure, the system performs (above noted) the identifying, the forming, the generating, the applying, the receiving the input data and the updating with the updated historical data iteratively until the count of the fraud transactions is greater than or equal to the threshold. The system then employs the multi-class ML model for fraud detection after the training the multi-class ML model.

According to one more aspect of the present disclosure, the system receives a second historical data before the specific time instance noted above. If the second historical data contains no transactions tagged as fraud, the system trains, based on the second historical data, a second one-class anomaly detection ML model, and applies the second one-class ML model to a second set of transactions of a second inference data to identify whether each transaction is an anomaly or not. Upon receiving a second input data indicating whether each transaction identified as the anomaly is a fraud transaction or not, the system updates the second historical data by adding the second set of transactions and tagging each fraud transaction as being fraud.

According to yet another aspect of the present disclosure, for generating the one-class ML model noted above, the system trains, based on the training data, a new one-class ML model. The system then applies the new one-class ML model to the test data, whereby the test data is provided as input to the new one-class ML model and a third set of transactions predicted as being anomalous by the new one-class ML model is received as output. If the third set of transactions includes all of the fraud transactions (identified above), the system selects the new one-class ML model as the one-class ML model. Otherwise, the system determines new values for one or more parameters provided as inputs for the training of the new one-class model and repeats the training and the applying with the one or more parameters set to the new values. In one embodiment, the new one-class ML model is based on SVM (Support Vector Machine), with the one or more parameters including an outlier rate.

According to an aspect of the present disclosure, for forming the training data and test data noted above, the system splits the first historical data into the training data and the test data according to a ratio. The system determines one or more transactions tagged as fraud in the training data and then transfers the one or more transactions from the training data to the test data such that the training data is devoid of fraud transactions and the test data includes all the fraud transactions.

According to another aspect of the present disclosure, the system receives at the specific time instance (noted above) a third historical data and a training window. The system then filters the transactions contained in the third historical data based on the training window to obtain the first historical data.

According to one more aspect of the present disclosure, for receiving the input data (noted above), the system sends for display, each transaction identified as an anomaly and receives, from one or more users, the input data indicating whether each of the set of transactions is a fraud transaction or not.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

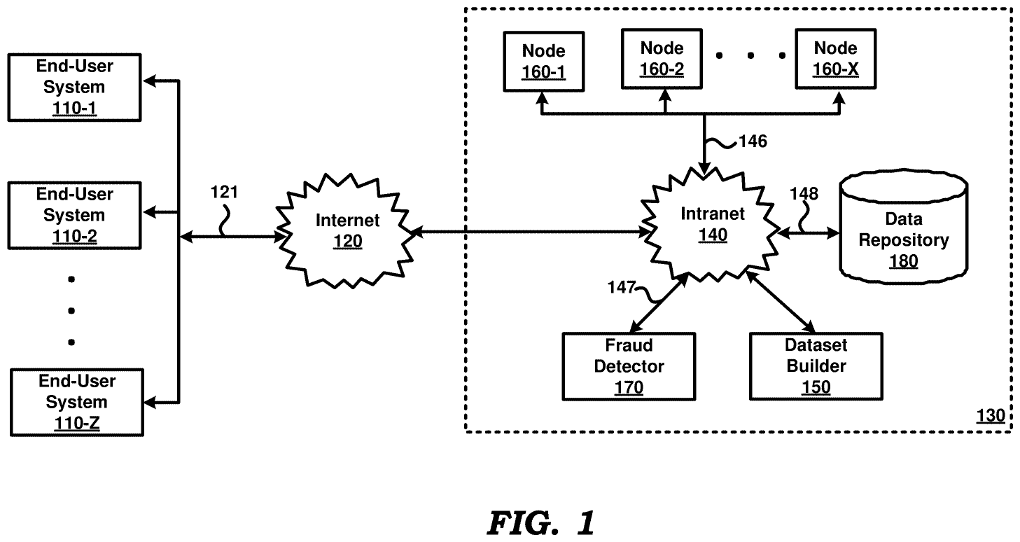

FIG. 1 is a block diagram illustrating an example environment in which several aspects of the present disclosure can be implemented. The block diagram is shown containing end-user systems 110-1 through 110-Z (Z representing any natural number), Internet 120, and computing infrastructure 130. Computing infrastructure 130 in turn is shown containing intranet 140, nodes 160-1 through 160-X (X representing any natural number), dataset builder 150, fraud detector 170, and data repository 180. The end-user systems and nodes are collectively referred to by 110 and 160 respectively.

Merely for illustration, only representative number/type of systems are shown in FIG. 1. Many environments often contain many more systems, both in number and type, depending on the purpose for which the environment is designed. Each block of FIG. 1 is described below in further detail.

Computing infrastructure 130 is a collection of nodes (160) that may include processing nodes, connectivity infrastructure, data storages, administration systems, etc., which are engineered to together host software applications. Computing infrastructure 130 may be a cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand.

Alternatively, computing infrastructure 130 may correspond to an enterprise system (or a part thereof) on the premises of the customers (and accordingly referred to as “On-prem” infrastructure). Computing infrastructure 130 may also be a “hybrid” infrastructure containing some nodes of a cloud infrastructure and other nodes of an on-prem enterprise system.

Intranet 140 provides connectivity between nodes 160 and performance manger 150. Internet 120 extends the connectivity of these (and other systems of computing infrastructure 130) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Each of end-user systems 110 represents a system such as a personal computer, workstation, mobile device, computing tablet etc., used by users to generate (user) requests directed to software applications executing in computing infrastructure 130. A user request can be a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system requests a software application for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or software application, with the IP packet including data identifying the desired tasks in the payload portion.

Some of nodes 160 may be implemented as corresponding data stores. Each data store represents a non-volatile (persistent) storage facilitating storage and retrieval of data by software applications executing in the other systems/nodes of computing infrastructure 130. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 160 may be implemented as corresponding server systems. Each server system represents a server, such as a web/application server, constituted of appropriate hardware executing software applications capable of performing tasks requested by end-user systems 110. In general, a server system receives a user request from an end-user system and performs the tasks requested in the user request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end-user system (one of 110) as a corresponding response to the user request. The results may be accompanied by specific user interfaces (e.g., web pages) for displaying the results to a requesting user.

In one embodiment, a business entity deploys desirable software applications in one or more nodes 160 of computing infrastructure 130. The software applications provide various online financial services (e.g., bank accounts, loans, credit cards, insurance, etc.) to customers of the business entity (using end-user systems 110). Specifically, customers using end-user systems 110 are facilitated to perform desired transactions (e.g., credit/debit/transfer amounts, apply for loan/card/insurance, claim insurance, etc.) related to such online services.

Data repository 180 represents a non-volatile storage (similar to data store noted above) that stores details of such computer implemented transactions performed by end-users/customers. The transactions are accumulated over a period of time (e.g., week, month, year) to form historical data. In alternative embodiments, the historical data (or portions thereof) may be maintained in some of nodes 160, implemented as data stores. According to an aspect, such historical data is used as the basis for fraudulent analysis as described below.

Fraud detector 170 is a computing system (similar to server system noted above) that performs detection of fraudulent transactions, that is, transactions that are deemed to involve deception, specifically with criminal intent. In one embodiment, fraud detector 170 employs a two-class classification predictive model (a machine learning (ML) model) that has the ability to identify fraud transactions, with fair degree of accuracy for data-in-motion (transactions performed at nodes 160). In general, for detecting frauds, multi-class ML models are preferred due to the ability to measure type I and Type II errors, as is well known in the arts.

However, building a two-class classification model is subject to the availability of historical fraud data containing requisite number of fraud samples (transactions tagged as fraud). Such historical fraud data forms the basis of training the two-class classification model.

In the absence of such historical identified fraud data, a common practice is to use anomaly detection techniques on data-at-rest (stored in data repository 180) to identify not-normal transactions. It is imperative to point out that anomalous transactions are not frauds, and at best, are outlier transactions which do not conform to routine or normal behavior.

For business entities, the goal is to move from a ‘No known history’ (of fraud samples) situation to building a valid corpus of fraud data (containing the requisite number of fraud samples), so that the two-class classification model (noted above) can be trained and deployed in fraud detector 170 (which thereafter operates on data-in-motion, to flag transactions as they pass through the systems of computing infrastructure 130).

Dataset builder 150, provided according to several aspects of the present disclosure, builds a dataset having requisite number of fraud samples to train a multi-class ML model (such as the two-class classification predictive model noted above) for fraud detection, as described below with examples.

### 3. Building Dataset with Requisite Number of Fraud Samples

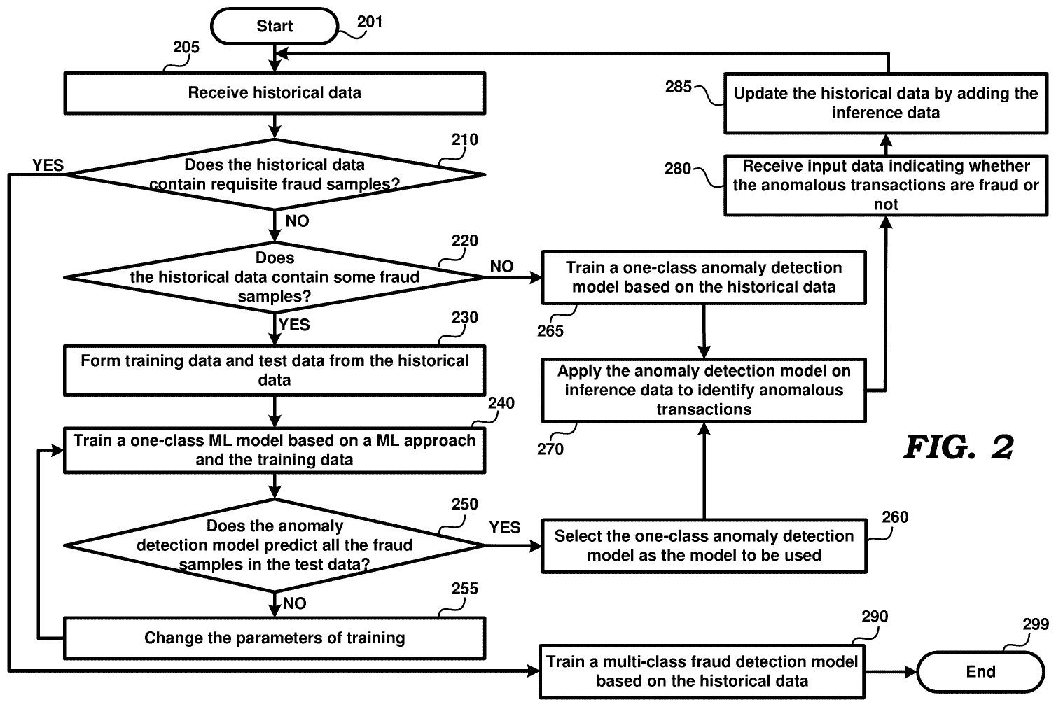

FIG. 2 is a flow chart illustrating the manner in which a dataset having requisite number of fraud samples to train a multi-class machine learning model for fraud detection is built according to aspects of the present disclosure. The flowchart is described with respect to the systems of FIG. 1, in particular dataset builder 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 205.

In step 205, dataset builder 150 receives historical data containing details of one or more transactions performed by users/customers using end-user systems 110. The historical data may be retrieved from data repository 180 (or nodes 160) and may be received periodically (for example, end of every week/month) for fraud detection. The description is continued assuming that the historical data is received at a specific time instance.

In step 210, dataset builder 150 checks whether the historical data contains requisite fraud samples, that is whether count of the transactions tagged as fraud is equal or above a pre-determined threshold (e.g., 200). In one embodiment, dataset builder 150 identifies records/transactions previously tagged as fraud (“fraud samples”) in the historical data. If the historical data includes the requisite number of fraud samples (count >=threshold), control passes to step 290, and to step 220 otherwise (count <threshold).

In step 220, dataset builder 150 checks whether the historical data contains some fraud samples. If at least one fraud sample exists (the count of the fraud samples is greater than 0), control passes to step 230, and to step 265 otherwise (count=0).

In step 230, dataset builder 150 forms training data and test data from the historical data. The test data is formed to include all the fraud records identified in step 210. Dataset builder 150 then generates, based on the training data, a one-class machine learning (ML) model that is able to predict/flag all the fraud records when the test data is provided as input to the one-class ML model, as described in detail below.

In step 240, dataset builder 150 trains a one-class anomaly detection ML model using the training data (formed in step 230). As is well known, a one-class ML-model (after training) merely predicts whether a given transaction is an anomaly or not an anomaly. Such prediction can be either a binary value (representing anomaly or not) along with a confidence score (e.g. probability). Any unsupervised model building techniques such as SVM (Support Vector Machine) may be used to train/build the one-class anomaly detection model.

In step 250, dataset builder 150 determines whether the one-class ML model predicts all the fraud samples/records in the test data. In particular, dataset builder 150 applies the one-class ML model to the test data, whereby the test data is provided as input to the one-class ML model and a set of records predicted as being fraud by the one-class ML model is received as output. If the predicted set of records includes all of the previously identified set of fraud records, control passes to step 260 and to step 255 otherwise.

In step 255, dataset builder 150 changes the parameters provide as inputs to the training of step 240 and control passes to step 240, where a new one-class ML model is trained based on the changed parameters. The change of the parameters may entail determining new values for the one or more parameters. An example of such a parameter used in building anomaly detection models is outlier rate that is provided as an input to training/building SVM based models. Thus, steps 240 through 255 are repeatedly performed using different values for the parameters until the one-class ML model is able to predict all of the previously identified fraud records.

In step 260, dataset builder 150 selects the one-class anomaly detection model (that is able to predict all of the fraud records) as the model to be used. Control pass to step 270.

In step 265, when the count of fraud records=0, dataset builder 150 trains a one-class ML model based on the (whole) historical data. The specific ML technique used for training the one-class ML model for this scenario may be the same technique as noted in step 240. Control passes to step 270.

In step 270, dataset builder 150 applies the anomaly detection model (selected in step 260 or trained in step 265) on inference data to identify anomalous transactions. Such applying may entails providing each of a set of transactions contained in the inference data as an input to the anomaly detection model, and receive as output an indication of whether the input transaction is an anomaly or not. In one embodiment, the indication is that the binary value=anomaly and that the probability >=0.8.

In step 280, dataset builder 150 receives input data indicating whether the anomalous transactions are fraud or not. According to an aspect, each anomalous transaction identified by the anomaly detection model is sent for display to one of end user systems 110, whereby the details of the anomalous transactions are displayed on display units associated with end user systems 110. Dataset builder 150 then receives, from one or more users, the input data indicating whether each of the set of anomalous transactions is a fraud transaction or not.

In step 285, dataset builder 150 updates the historical data by adding the inference data along with tagging each fraud transaction as being fraud to form an updated historical data. The updated historical data is stored in data repository 180. Control passes to step 205, wherein the steps of FIG. 2 noted above are performed with respect to the updated historical data.

In step 290, when the count of fraud records >=threshold, a multi-class ML model (such as the two-class classification predictive model noted above) is trained based on the (whole) updated historical data. In one embodiment, dataset builder 150 sends an indication to fraud detector 170, which in turn may initiate the building of the two-class classification predictive model based on the updated historical data maintained in data repository 180. Control passes to step 299, where the flowchart ends.

According to an aspect, dataset builder 150 receives (in step 205) a training window along with a superset historical data. Dataset builder 150 then filters the transactions contained in the superset historical data based on the training window to obtain the first historical data. The training window may specify a start time instance and an end time instance, and accordingly filtering may entail identifying only the transactions performed between the start and end time instances.

Thus, aspects of the present disclosure facilitate the building of a valid corpus of fraud data. In the absence of historical identified fraud data (that is fraud samples, n=0), a one-class ML model is applied on data-at-rest to identify not-normal transactions. During the intermediate transition phase when 0<n<N, dataset builder 150 uses the few fraud samples available to build and cross validate the predicted anomalies with the already identified fraud records. The effectiveness of the built anomaly detection model may be measured in strike rate metric (described in below sections), which is calculated as how many of the fraud records are included in the predicted anomalies. The ability to identify suspect transactions, with fair degree of accuracy for data-in-motion scenarios is addressed by training a multi-class ML model once the requisite number of fraud samples (N) is reached (that is, n>=N).

It should be noted that the three different scenarios (n=0, 0<n<N and n>=N) will not be present at the same time, and accordingly by extension only one of the ML models-anomaly detection model selected in step 260, the anomaly detection model trained in step 265 and the multi-class ML model trained instep 290 may be present in the systems of computing infrastructure 130.

The manner in which dataset builder 150 is implemented to provide several aspects of the present disclosure according to the steps of FIG. 2 is illustrated below with examples. The description is clearer with the details of an example representation of historical data described below examples.

### 4. Historical Data

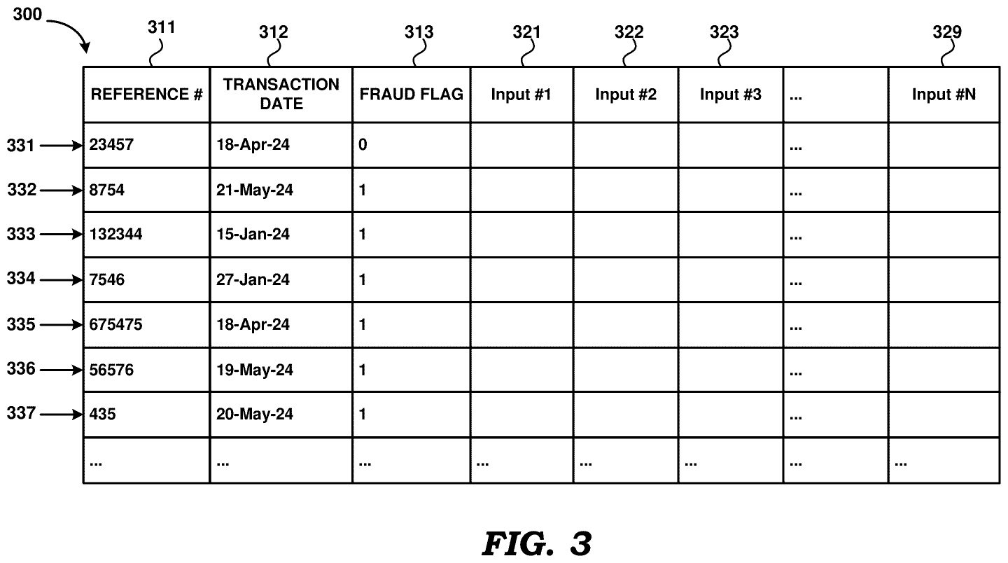

FIG. 3 depicts the manner in in which historical data is maintained in one embodiment. For illustration, the historical data is shown maintained as a database table (300) in data repository 180. However, in alternative embodiments, the setup data may be maintained according to other data formats (such as extensible markup language (XML), JSON (JavaScript Object Notation), etc.) and/or using other data structures (such as lists, trees, etc.), as will be apparent to one skilled in the relevant arts by reading the disclosure herein.

Table 300 depicts portions of historical data. Column 311 “REFERENCE #” specifies a reference number that uniquely identifies a record/transaction, that is, a unique identifier. Column 312 “TRANSACTION DATE” specifies a transaction date on which the transaction was performed and is used to filter the training window. Column 313 “FRAUD FLAG” is an indicator flag that specifies the fraud status of the record/transaction, with value 0 indicating fraud and value 1 indicating non-fraud/normal. Columns 311-313 are mandatory in the historical data.

Any additional status of the records such as whether a record has been processed by a prediction model is assumed to be handled using additional data, for example, in a separate column in table 300.

Columns 321-329 “Input #1” to “Input #N” represent input fields of the transaction that are determined by the nature of the transaction performed with the business entity. For example, when the transaction is a credit/debit/transfer, the input fields may be initiating account, receiving account, amount, device identifier, IP (Internet Protocol) address of the initiating device, etc. Such input fields may be maintained in one or more application tables (not shown) in nodes 160 and may be extracted, transformed, and populated into table 300 in a known way as will be apparent to one skilled in the relevant arts. Though only a few input fields are shown in table 300, there may be more or less inputs specific to the implementation of the historical data. The description is continued assuming the number of inputs N in table 300 is 20.

Each of rows 331-337 specifies the details of a corresponding record/transaction. For example, row 331 indicates that the transaction with identifier “23457” was performed on “18 Apr. 2024” and has the fraud status as fraud (value 0). On the other hand, row 332 indicates that the transaction with identifier “8754” performed on “21 May 2024” has the fraud status as not-fraud (value 1). Similarly, rows 333-337 indicate other records/transactions of the historical data.

Thus, dataset builder 150 maintains portions of the historical data. The description is now continued with respect to the internals of dataset builder 150 in an embodiment.

### 5. Dataset Builder

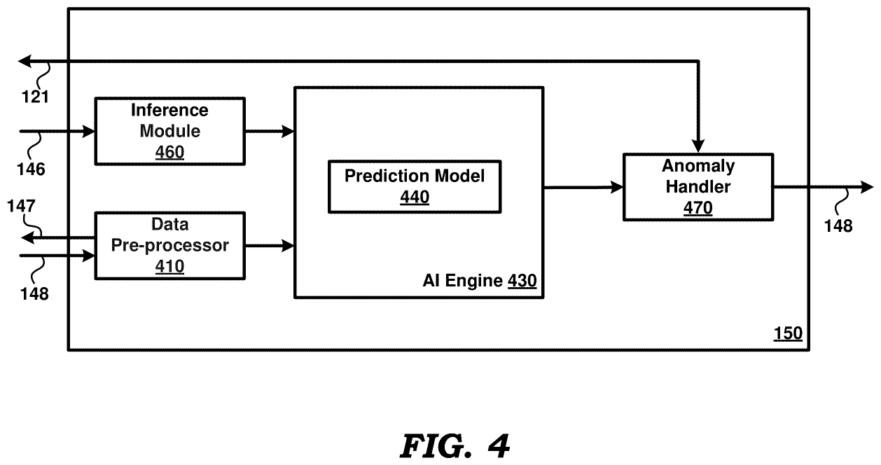

FIG. 4 is a block diagram of a dataset builder (150) according to several aspects of the present disclosure. The block diagram is shown containing data pre-processor 410, artificial intelligence (AI) engine 430 (in turn, shown containing prediction model 440), inference module 460, and anomaly handler 470. Each of the blocks in the Figure is described in detail below.

Data pre-processor 410 receives (via path 148) historical data (or portions thereof) from data repository 180 along with a training window, and filters the records in the historical data based on the start and end time instances specified by the received training window. The training window may be received from a user (such as an administrator of the business entity) using end-user system 110 or may be specified as part of a configuration data, and may be received along with the historical data via path 148.

Data pre-processor 410 identifies the fraud records (having 0 in indicator flag/column 313) in the filtered historical data. Data pre-processor 410 then compares a count of the fraud records with a pre-defined threshold. The threshold may be determined by adopting a common industry practice, for example, number of fraud samples should be ten times more than the number of degrees of freedom of the data model. Degrees of freedom is typically the number of input fields in the model. Thus, in the embodiment noted above, the threshold X is calculated as =Number of input fields in table 300*10=20*10=200.

In the scenario the count is equal to or above the threshold (200), data pre-processor 410 sends (via path 147) a signal/indication to fraud detector 170 to cause generation of a multi-class ML model based on the updated historical data in data repository 180.

In the scenario the count is less than the threshold, data pre-processor 410 performs pre-processing on the transaction/records contained in the historical data and forwards the processed records to AI engine 430. Pre-processing includes but is not limited to removing incorrect/incomplete data, discretization of data, normalization of data, identification of feature set, etc. as is well known in the relevant arts.

AI engine 430 generates and maintains various prediction models (such as prediction model 440) that collate the data received from data pre-processor 410. The prediction models may be generated using any machine learning (ML) approaches such as SVM (Support Vector Machine), KNN (K Nearest Neighbor), Decision Tree, etc. or deep learning (DL) approaches such as Multilayer Perceptron (MLP), Convolutional Neural Networks (CNN), Long short-term memory networks (LSTM) etc. Various other machine/deep learning approaches can be employed, as will be apparent to skilled practitioners, by reading the disclosure provided herein.

AI engine 430 first checks whether there is at least one fraud record (having 0 in indicator flag/column 313) in the pre-processed transactions/records received from data pre-processor 410. If there are no such fraud records (count=0), AI engine 430 builds prediction model 440 as a one-class SVM (Support Vector Machine), which is an unsupervised approach to detect anomalies. As is well known, one-class SVM model does not have target labels for model training purpose, instead it identifies a hyperplane that separates the majority of the data (records) from potential anomalies i.e. data outside the hyperplane are anomalies. It is particularly useful when anomalies are rare and not well-distributed (as is with transactions performed with a business entity). The one-class SVM model is associated with a parameter “Outlier Rate” that controls the manner in which the hyperplane is built. The outlier rate parameter represents the percentage of anomalies expected in a given dataset (here, historical data). A value of 0.01 means 1% outliers is expected in the given dataset.

If at least one fraud record is present (0<count <threshold), AI engine 430 forms a training data and a test data from the received historical data such that the test data includes all the identified fraud records. The separation of the historical data into the training data and test data may be performed in any convenient manner.

In one embodiment, AI engine 430 splits the historical data into a training data and a test data according to a ratio (e.g., 70:30). The split is based on a time instance (within the training window), with the transactions before the time instance forming the training data and the transactions after the time instance forming the test data. The time instance is selected such that the number of transactions before to after is as per the ratio. AI engine 430 then determines whether the (previously identified) one or more fraud records are present in the training data, and if present, transfers the fraud records from the training data to the test data such that the training data is devoid of fraud records (number=0) and the test data includes all the fraud records.

AI engine 430 then generates/builds prediction model 440 as a one-class SVM built using an initial outlier rate. AI engine 430 then applies prediction model 440 to the test data, that is, provides the test data as input to the prediction model 440 to receive a set of records predicted as being fraud as output. If the predicted set of records includes all of the fraud records (contained in the test data), AI engine 430 selects prediction model 440 at the finalized model to be used for anomaly detection.

On the other hand, if the predicted set of records does not include all the fraud records, AI engine 430 rebuilds prediction model 440 using a new value for the outlier rate, and performs the above noted steps of applying and checking until prediction model 440 generated based on the training data (and a final outlier rate) is able to predict all the fraud records in the test data.

Inference module 460 receives (via path 146) inference data containing the details of transactions performed at nodes 160 by users/customers of the business entity using end-user systems 110. Inference module 460 may perform pre-processing similar to data-preprocessor 410 and forwards the processed data to prediction model 440.

Anomaly handler 470 receives the transactions/records indicated to be anomalies by prediction model 440, and may update the status of the received records (as “Suspect”) in the historical data stored in data repository 180 by sending appropriate requests via path 148. In one embodiment, anomaly handler 470 also facilitates end users (such as staff of the business entity) to manually investigate and indicate whether each suspect transaction is a fraud or not by providing appropriate user interfaces to end-user systems 110. The results of such investigations may be received by anomaly handler 470 and subsequently updated to data repository 170. An example user interface that may be provided to end users for manual investigation is described below with examples.

### 6. Investigation Dashboard

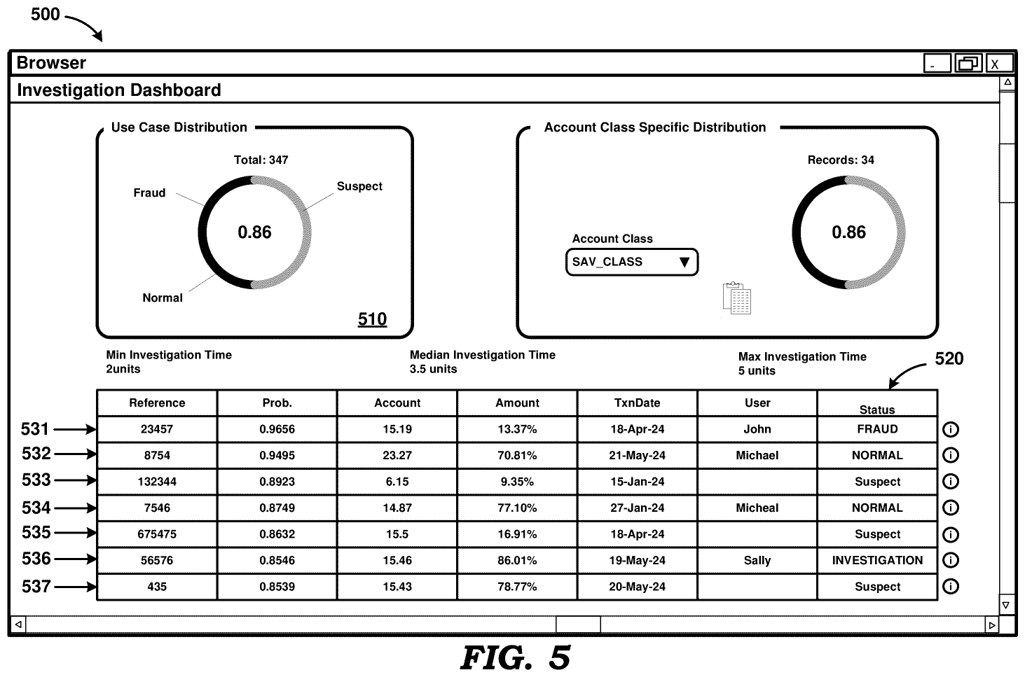

FIG. 5 illustrates a user interface provided for manual investigation of suspected anomalous transactions in one embodiment. Display area 500 represents a portion of a user interface displayed on a display unit (not shown) associated with one of end-user systems 110. In one embodiment, display area 500 corresponds to a web page rendered by a browser executing on the end-user system. The web pages may be provided by dataset builder 150 in response to a user (e.g., technician) sending appropriate requests (for example, by specifying corresponding Uniform Resource Locator (URL) in an address bar) using the browser.

Display area 500 depicts portions of an investigation dashboard displayed to a user using one of end-user systems 110. Broadly, the investigation dashboard is designed to show all flagged anomalies as SUSPECT and after due investigation/processing by users, are deemed either FRAUD or NORMAL. It is a manual user driven process. The outcome status of fraud or not-fraud is inserted in the historical data for future model building. This is the incremental addition to the fraud corpus.

Display area 510 accordingly indicates the number of transactions identified to be suspect (by anomaly handler 470), the number of such transactions that have been investigated and indicated to be fraud and the number of such transactions that have been investigated and indicated to be normal (not fraud).

Display area 520 depicts a table of transactions/records provided by dataset builder 150, in particular, anomaly handler 470. Specifically, each transaction indicated to be anomalous by prediction model 440 is indicated to be Suspect as shown in display areas/rows 533, 535 and 537. The specific records may thereafter be assigned to specific users for manual investigation, and accordingly their status is changed to “INVESTIGATION” as shown in row 536. After manual investigation of the specific transaction using appropriate user interfaces (not shown), the assigned user may flag the transaction either as a “FRAUD” as shown in row 531 or as “NORMAL” as shown in rows 532 and 534.

Thus, users (such as staff of the business entity) use the investigative board of display area 500 for investigation of SUSPECT records. Each user may be allowed to view only the investigation records assigned to them. Each user may view the assigned records and perform the following tasks-decision-fraud/non-fraud; provide justification-mandatory field and attach/upload supporting documents.

Thus, dataset builder 150 aids in anomaly detection during an intermediate transition phase, where the business entity has identified some fraud data, which is less than the minimum required fraud data to build a two-class classification model. The manner in which various aspects of the present disclosure operate (process flow) is described below with examples.

### 7. Process Flow

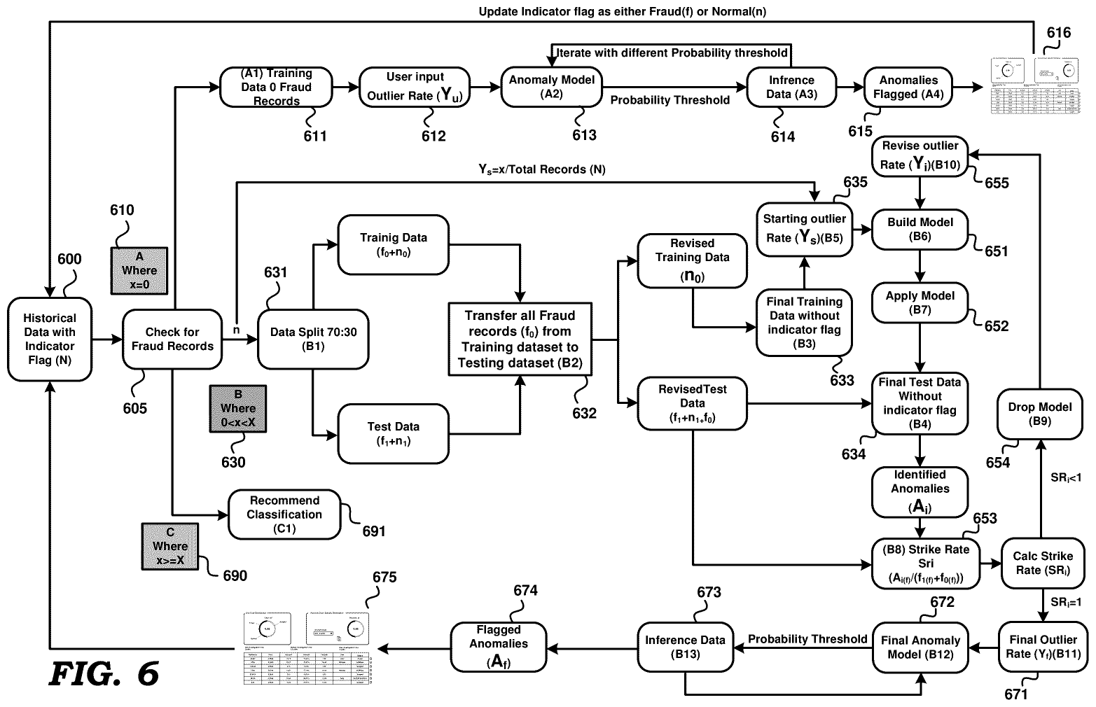

FIG. 6 illustrates a process flow of several aspects of the present disclosure in one embodiment. Broadly, the process is triggered by a user for building an anomaly detection model.

At 600, historical data with indicator flag (column 313) is provided as the input data to the process. In one embodiment, a parameter named historical window span(S) specifying a number of days prior to a last business date (LBD) to be considered in the training window is also received. Given an LBD such as “6 May 2024” and a value of S=100 days, the start time instance (From Date) is calculated as LBD-S=27 Jan. 2024, and the end time instance (To Date) is determined to be LBD=6 May 2024. In other words, the training window is 27 Jan. 2024 to 6 May 2024, and transactions having dates between the two dates (including being the same as the dates) are considered as part of the historical data. The description is continued assuming that the total number of records in the historical data being processed (N)=1175.

At 605, the historical data (or portion thereof) is checked for fraud records (count of FRAUD FLAG=0). Different paths A, B or C may be executed based on the number of fraud records present in the historical data.

Anomaly detection routine, Path A (610), represents the atypical scenario, where there are no known examples of fraud, i.e., 0 fraud records in the historical data (x=0).

Anomaly detection routine with outlier rate discovery, Path B (630), represents the intermediate scenario, where there some known examples of fraud records in the historical data, but not sufficient to build a classification model, that is, 0<x<X, where x, represents the total number of identified fraud examples in the historical dataset and X is the fraud records threshold, i.e., the minimum required number of fraud records to enable multi-class classification model building. This is an iterative process, where dataset builder 150 attempts to discover an optimal outlier rate to build the final anomaly model. The optimal outlier rate is determined as the outlier rate, where the anomaly detection model, can correctly flag all the fraud examples in the historical dataset.

Classification routine, Path C (690), represents the final scenario, where there are sufficient examples of fraud in the historical data to recommend building a classification model, which is the final goal of the fraud prevention journey (x>=X).

In general, flagged anomalies are fed into the ‘Investigation Dashboard’ (such as that shown in display area 500) as a SUSPECT. Every SUSPECT record is duly investigated and identified as a FRAUD or NORMAL. Investigation of anomalies is part of manual business operation. The process loop is finally closed by updating the historical data set FRAUD FLAG, as 0 for FRAUD, and 1 for NORMAL.

It may be appreciated that only one of the Paths A, B, or C is executed automatically when a user triggers model building. Each of the paths is described in detail below.

### Path A

In path A, at 611, the training/historical data set (A1) solely consists of normal or routine data i.e. completely devoid of any fraud examples. Column FRAUD FLAG may be excluded from the training dataset, as this is what is being attempted to flag using the anomaly detection model. Column TRANSACTION DATE is also excluded, as it has served its purpose having filtered the training examples.

At 612, outlier rate, Yᵤ, is a user provided input parameter and is usually determined as a percentage of the data that is expected to be anomalous. Usually based on business intuition, in the absence of verified fraud examples—0<Yᵤ<1, default is 0.01.

At 613, anomaly detection model (A2) is built using Yᵤ as outlier rate parameter. Both training data set A1 and outlier rate Yᵤ are input to model building. The resultant model may be stored as a database artifact.

At 614, inference data (A3) is the new unseen data, presented in similar format as the training data model A1, i.e. excluding columns FRAUD FLAG and TRANSACTION DATE. Transactions that occur during the business day are referred to as data-in-motion. Once these transactions are completed, they become data-at-rest and are collated/transformed and added to the inference data corpus. The model A2 has not seen these new records hence unseen data.

Model A2, is to be applied on inference data, A3, to flag anomalies, based on user provided probability threshold during runtime execution, e.g., flag anomalies using model A2, where probability >=0.87. This may be a user driven iterative process, where model A2 is applied on A3 using different probability thresholds until the users of the business entity are satisfied with the desired outcome, A4.

At 615, flagged anomalies (A4) represents the output corresponding to new unseen data, A3. Each record in the anomalies list consists of unique identifiers flagged as anomalous, probability, and attributes and their weightages, that explains the anomaly decision.

At 616, investigation dashboard (an instance of 500) facilitates users to manually investigate the flagged anomalies. All flagged anomalies are displayed as SUSPECT status. The users investigate and conclude SUSPECT status as either FRAUD or NORMAL. The final status, post investigation is updated back to historical data (600) in column FRAUD FLAG.

### Path B

In path B, at 631, data split (B1) is the initial split of the base historical data using the standard industry methodology in a 70:30 ratio to create a training data set and a testing data set. Statistically after data split, the training data set will consist of f₀ (fraud examples) and no (normal examples), and the testing data set consists of f₁ (fraud examples) and n₁ (normal examples). In an example, f₀ equals 4 and f₁ also equals 4.

At 632, isolation (B2) transfers all the fraud examples from training data set, i.e. f₀, to the testing data set. The output of B2 is a revised training data set consisting of only no (normal examples), and a revised testing data set consisting of f₁ (initial fraud examples in testing data), n₁ (initial normal examples in testing data), and transferred f₀ fraud examples from the training dataset to the testing dataset. In other words, the revised test data now contains f₀+f₁=8 fraud examples.

At 633, final training data (B3) consists of the revised training data with the following transformations—(1) Column FRAUD FLAG is excluded from the training dataset, as this is what is being attempted to be flagged using the ML model; and (2) Column TRANSACTION DATE is also excluded, as it has served its purpose having filtered the training examples. Thus, the final training data excludes columns FRAUD FLAG and TRANSACTION DATE.

At 634, final test data (B4) consists of the revised test data with the following transformations-(1) Column FRAUD FLAG is excluded from the test dataset, as this is what is being attempted to be flagged using the ML model; and (2) Column TRANSACTION DATE is also excluded, as it has served its purpose having filtered the training examples. Thus, the final test data excludes columns FRAUD FLAG and TRANSACTION DATE.

### At 635, Starting Outlier Rate (B5) is Calculated as:

$${Y}_{s} = x / N$$

where,
   x is the number of fraud examples in the historical data within the historical window span; and
   N is the total number of records in the historical data within the historical window span.

As noted above, the outlier rate specifies a percentage of data that is expected to be anomalous in the population. For the example noted above, Yₛ=8/1175=0.00681.

At 651, model build (B6) builds a model using the anomaly detection model (one-class ML model) using the one class SVM (Support Vector Machine) ML approach. The initial outlier rate when set as parameter to such model building builds a hyperplane layer to discriminate between normal/atypical and not-normal data. This allows the model to approximately identify/flag not-normal cases, outside this hyperplane layer, proportional to the outlier rate, when applied to a population (historical data).

Using the starting outlier rate Yₛ, calculated as part of previous B5 step, the model is built, and the following metrics are documented—SVMS_SOLVER, CONVERGED and OUTLIER RATE/SENSITIVITY.

At 652, model applied (B7)—the trained model of previous stage B6, is applied on the final test data derived from stage B4 and anomalies (fraud records) are flagged as Aᵢ. The description is continued assuming that for Yₛ=0.00681, the number of anomalies/fraud records correctly flagged=4.

At 653, strike rate SRᵢ (B8) is calculated as the total number of instances flagged as anomalies in the final testing data divided by the number of actual fraud instances in the revised testing data set, for the same unique identifiers of the fraud instances.

Both the datasets, final testing data and revised testing data, have the same data examples. The only difference being ‘revised testing data’ has an extra column to identify the fraud examples. This is done to enable the system to calculate the denominator value, by counting all the actual fraud examples in the ‘revised testing data’. while the numerator is the count of anomalies flagged by the model in the ‘final testing data’. The objective being, at some optimum value of outlier rate, the model should be able to flag all the actual fraud examples.

$${SR}_{i} = \sum {A}_{i ( ref )} / ( {f}_{1} + {f}_{0} )$$

where,
   i represents the iteration;
   ref represents the group of unique identifiers of the fraud instances in the revised testing data set;
   ΣA_{i(ref)} is the count of unique identifiers flagged as anomalies from the group of unique identifiers in the revised test data, identified as fraud;
f₁ is the count of unique identifiers from the original fraud examples in the revised test data;
f₀ is the count of unique identifiers from the transferred fraud examples in the revised test data; and
SRᵢ is the strike rate for iteration i.

In the above example, when Yₛ=0.00681, the ΣA_{i(ref)}=4, f₁=4, f₀=4, giving a strike rate SRᵢ=4/(4+4)=½=0.5

As long as calculated SRᵢ<1, not all the fraud examples represented by unique identifiers, in the revised test data have been flagged as anomalies and accordingly the iteration is continued, through stage B9, until SRᵢ=1 is achieved. When calculated SRᵢ=1, iteration is stopped, and the process proceeds to stage B11 described below.

At 654, drop model (B9)—after the first stage of iteration, if calculated SR; <1, the trained model built using starting outlier rate Yₛ is dropped in preparation for the next iteration.

At 655, revised outlier rate (B10) is arrived at by:

$${Y}_{i} = {Y}_{p} + {L}_{r}$$

where,
   Yᵢ is the revised outlier rate for the current iteration;
   Yₚ is the outlier rate of the previous iteration; and
   Lᵣ is the learning rate, which is a pre-agreed upon rate (default value is 0.01).

Accordingly, in the above example, the revised outlier rate Yᵢ=0.00681+0.01=0.01681. Multiple iterations of steps 651-655 may then be performed for outlier rate discovery. The iterations are done to discover an outlier rate value i.e. repeatedly training the model on the same training data but using different outlier rates. For each iteration, the model is trained on final training data using a revised outlier rate and applied on the final testing data. The flagged anomalies from final testing data are then cross verified with the confirmed fraud records in the revised testing data to arrive at the strike rate. The iteration end when SRᵢ=1.

In the above example, a representative set of iterations to discover the optimum outlier rate is shown in the below table:

| | Outlier Rate | Correctly Flagged | Strike Rate |
|---|---|---|---|
| Iteration # | (Yₛ/Yᵢ) | (ΣA_{i(ref)}) | SRᵢ |
| 1 | 0.00681 | 4 | 0.500 |
| 2 | 0.01681 | 5 | 0.625 |
| 3 | 0.02681 | 5 | 0.625 |
| . . . | . . . | . . . | . . . |
| 31 | 0.30681 | 7 | 0.875 |
| 32 | 0.31681 | 8 | 1.000 |

At 671, final outlier rate (B11) is determined after the iteration process exits when strike rate, SRᵢ=1. The final outlier rate, Y_{f} is the outlier rate of the last iteration, Yᵢ when SRᵢ=1. In the above example, Y_{f}=0.31681.

At 672, final anomaly model (B12) is built using Y_{f}, the final outlier rate and persisted in the database.

At 673, inference data (B13) represents the new unseen data in similar format as the final training data model B3, i.e. excluding columns FRAUD FLAG and TRANSACTION DATE. Model B12 is applied on the inference data (B13) to flag anomalies, based on user provided probability threshold during runtime execution, e.g., flag anomalies using model B12, where probability >=0.87. This may be a user driven Iterative process, where model B12 is applied on the inference data B13 using different probability thresholds until the users of the business entity are satisfied with the desired anomalies list A_{f}.

At 674, flagged anomalies (A_{f}) is a list of flagged anomalies in new unseen inference data. Each record in the anomalies list A_{f}, consists of (i) Account Number flagged as anomalous; (ii) Probability; and (iii) Attributes and their weightages, that explains the anomaly decision.

At 675, investigation dashboard (an instance of 500) facilitates users to manually investigate the flagged anomalies. All flagged anomalies A_{f}, are displayed as SUSPECT status. The users investigate and conclude SUSPECT status as either FRAUD or NORMAL. The final status, post investigation is updated back to historical data (600) in column FRAUD FLAG.

### Path C

In path C, the scenario represents the business goal of building a classification model, to be deployed on data-in-motion has been met (that is x>=X). At 691, recommend classification (C1) indicates that the system is recommended to switch from anomaly detection model to classification model, as the fraud corpus is ready (has sufficient number of fraud records).

Thus, at the beginning, an anomaly detection model is built using training data having all normal/routine data i.e. zero fraud data/samples. This trained anomaly detection model is applied on inference data or new data and anomalies are flagged. The flagged anomalies are investigated and classified as either fraud or normal. Such a process is iterative, and each iteration may give raise to some anomalies being classified as frauds.

As an outcome of such an iterative process, there exists an intermediate transition phase, where any business entity has identified some fraud data, n, which is less than the minimum required fraud data, N, to build a two-class classification model. In other words, in the intermediate scenario where 0<n<N, i.e. some fraud data exists but not sufficient to implement two-class classification techniques.

Dataset builder 150 is designed to handle the intermediate transition stage. A new metric “Strike Rate” is introduced to address the transition stage. Any fraud data, if present, is used to derive the starting outlier rate and iteratively re-train the model by changing the outlier rate and evaluating the Strike Rate. Such an implementation enables seamless building of fraud corpus data from zero fraud data.

Many organizations/institutions lack the ability to detect fraud on data-in-motion i.e. as the transactions are executed on-the-fly due to lack of fraud corpus data to train the models on. The proposed solution allows such organizations a seamless mechanism to build fraud corpus data, where none existed. The close integration of the anomaly detection workflow with the investigation dashboard enables institutions to operationalize their fraud detection strategy and also provides a singular enterprise-wide view of the fraud data.

It should be further appreciated that the features described above can be implemented in various embodiments as a desired combination of one or more of hardware, executable modules, and firmware. The description is continued with respect to an embodiment in which various features are operative when the software instructions described above are executed.

### 8. Digital Processing System

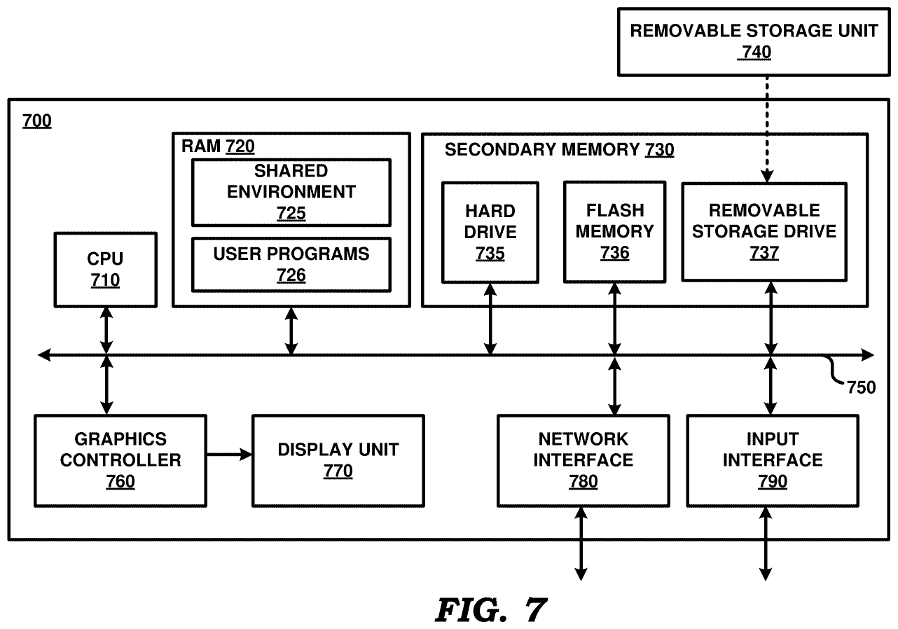

FIG. 7 is a block diagram illustrating the details of digital processing system (700) in which various aspects of the present disclosure are operative by execution of appropriate executable modules. Digital processing system 700 may correspond to dataset builder 150 (or any system implementing dataset builder 150).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726 (such as other applications, DBMS, etc.). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals (such as the portions of the user interface shown in FIG. 5). Input interface 790 may correspond to a keyboard and a pointing device (e.g., touch-pad, mouse) and may be used to provide inputs (such as those required for the user interface shown in FIG. 5). Network interface 780 provides connectivity to a network (e.g., using Internet Protocol), and may be used to communicate with other systems connected to the networks.

Secondary memory 730 may contain hard drive 735, flash memory 736, and removable storage drive 737. Secondary memory 730 may store the data (e.g., data portions of FIG. 3) and software instructions (e.g., for implementing the steps of FIG. 2, for implementing the blocks of FIGS. 4 and 6), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A computer implemented method comprising:
receiving a first historical data at a first time instance;
identifying a first set of transactions tagged as fraud in said first historical data;
if a count of said first set of transactions is below a threshold:
forming a training data and a test data from said historical data, wherein said test data includes said first set of transactions tagged as fraud;
generating, based on said training data, a first one-class machine learning (ML) model that is able to predict said first set of transactions when said test data is provided as input to said first one-class ML model;
applying said first one-class ML model to a set of transactions of an inference data to identify whether each transaction is an anomaly or not;
receiving an input data indicating whether each transaction identified as said anomaly is a fraud transaction or not; and
updating said first historical data by adding said set of transactions and tagging each fraud transaction as being fraud to form an updated historical data,
wherein said updated historical data is used for training a multi-class ML model after said count of said first set of transactions is greater than or equal to said threshold.

2. The method of claim 1, wherein said identifying, said forming, said generating, said applying, said receiving said input data and said updating is performed with said updated historical data iteratively until said count of said first set of transactions is greater than or equal to said threshold,
said method further comprising employing said multi-class ML model for fraud detection after said training said multi-class ML model.

3. The method of claim 1, further comprising:
receiving a second historical data before said first time instance;
wherein if said second historical data contains no transactions tagged as fraud:
training, based on said second historical data, a second one-class machine learning (ML) model;
applying said second one-class ML model to a second set of transactions of a second inference data to identify whether each transaction is an anomaly or not;
receiving a second input data indicating whether each transaction identified as said anomaly is a fraud transaction or not; and
updating said second historical data by adding said second set of transactions and tagging each fraud transaction as being fraud.

4. The method of claim 1, wherein said generating comprises:
training, based on said training data, a new one-class ML model;
applying said new one-class ML model to said test data, wherein said applying comprises providing said test data as input to said new one-class ML model and receiving as output a third set of transactions predicted as being anomalous by said new one-class ML model;
if said third set of transactions includes all of said first set of transactions:
selecting said new one-class ML model as said first one-class ML model; otherwise:
determining new values for one or more parameters provided as inputs for said training of said new one-class model; and
repeating said training and said applying with said one or more parameters set to said new values.

5. The method of claim 5, wherein said new one-class ML model is based on SVM (Support Vector Machine), wherein said one or more parameters comprises an outlier rate.

6. The method of claim 1, wherein said forming comprises:
splitting said first historical data into said training data and said test data according to a ratio;
determining one or more transactions tagged as fraud in said training data; and
transferring said one or more transactions from said training data to said test data such that said training data is devoid of transactions tagged as fraud and said test data includes all transactions tagged as fraud.

7. The method of claim 6, wherein said receiving receives at said first time instance a third historical data and a training window,
said method further comprising filtering the transactions contained in said third historical data based on said training window to obtain said first historical data.

8. The method of claim 7, wherein said receiving said input data comprises:
sending for display, each transaction identified as said anomaly; and
receiving, from one or more users, said input data indicating whether each of said set of transactions is said fraud transaction or not.

9. A non-transitory machine-readable medium storing one or more sequences of instructions for aiding fraud detection, wherein execution of said one or more instructions by one or more processors contained in a digital processing system causes said digital processing system to perform the actions of:
receiving a first historical data at a first time instance;
identifying a first set of transactions tagged as fraud in said first historical data;
if a count of said first set of transactions is below a threshold:
forming a training data and a test data from said historical data, wherein said test data includes said first set of transactions tagged as fraud;
generating, based on said training data, a first one-class machine learning (ML) model that is able to predict said first set of transactions when said test data is provided as input to said first one-class ML model;
applying said first one-class ML model to a set of transactions of an inference data to identify whether each transaction is an anomaly or not;
receiving an input data indicating whether each transaction identified as said anomaly is a fraud transaction or not; and
updating said first historical data by adding said set of transactions and
tagging each fraud transaction as being fraud to form an updated historical data, wherein said updated historical data is used for training a multi-class ML model after said count of said first set of transactions is greater than or equal to said threshold.

10. The non-transitory machine-readable medium of claim 9, wherein said identifying, said forming, said generating, said applying, said receiving said input data and said updating is performed with said updated historical data iteratively until said count of said first set of transactions is greater than or equal to said threshold,
further comprising one or more instructions for employing said multi-class ML model for fraud detection after said training said multi-class ML model.

11. The non-transitory machine-readable medium of claim 9, further comprising one or more instructions for:
receiving a second historical data before said first time instance;
wherein if said second historical data contains no transactions tagged as fraud:
training, based on said second historical data, a second one-class machine learning (ML) model;
applying said second one-class ML model to a second set of transactions of a second inference data to identify whether each transaction is an anomaly or not;
receiving a second input data indicating whether each transaction identified as said anomaly is a fraud transaction or not; and
updating said second historical data by adding said second set of transactions and tagging each fraud transaction as being fraud.

12. The non-transitory machine-readable medium of claim 9, wherein said generating comprises one or more instructions for:
training, based on said training data, a new one-class ML model;
applying said new one-class ML model to said test data, wherein said applying comprises providing said test data as input to said new one-class ML model and receiving as output a third set of transactions predicted as being anomalous by said new one-class ML model;
if said third set of transactions includes all of said first set of transactions:
selecting said new one-class ML model as said first one-class ML model; otherwise:
determining new values for one or more parameters provided as inputs for said training of said new one-class model; and
repeating said training and said applying with said one or more parameters set to said new values.

13. The non-transitory machine-readable medium of claim 9, wherein said forming comprises one or more instructions for:
splitting said first historical data into said training data and said test data according to a determining one or more transactions tagged as fraud in said training data; and
ratio;
transferring said one or more transactions from said training data to said test data such that said training data is devoid of transactions tagged as fraud and said test data includes all transactions tagged as fraud.

14. The non-transitory machine-readable medium of claim 13, wherein said receiving receives at said first time instance a third historical data and a training window,
further comprising one or more instructions for filtering the transactions contained in said third historical data based on said training window to obtain said first historical data.

15. A digital processing system comprising:
a random access memory (RAM) to store instructions for aiding fraud detection; and
one or more processors to retrieve and execute the instructions, wherein execution of the instructions causes the digital processing system to perform the actions of:
receiving a first historical data at a first time instance;
identifying a first set of transactions tagged as fraud in said first historical data;
if a count of said first set of transactions is below a threshold:
forming a training data and a test data from said historical data, wherein said test data includes said first set of transactions tagged as fraud;
generating, based on said training data, a first one-class machine learning (ML) model that is able to predict said first set of transactions when said test data is provided as input to said first one-class ML model;
applying said first one-class ML model to a set of transactions of an inference data to identify whether each transaction is an anomaly or not;
receiving an input data indicating whether each transaction identified as said anomaly is a fraud transaction or not; and
updating said first historical data by adding said set of transactions and tagging each fraud transaction as being fraud to form an updated historical data,
wherein said updated historical data is used for training a multi-class ML model after said count of said first set of transactions is greater than or equal to said threshold.

16. The digital processing system of claim 15, wherein said digital processing system performs the actions of said identifying, said forming, said generating, said applying, said receiving said input data and said updating with said updated historical data iteratively until said count of said first set of transactions is greater than or equal to said threshold,
said digital processing system further performing the actions of employing said multi-class ML model for fraud detection after said training said multi-class ML model.

17. The digital processing system of claim 15, further performing the actions of:
receiving a second historical data before said first time instance;
wherein if said second historical data contains no transactions tagged as fraud:
training, based on said second historical data, a second one-class machine learning (ML) model;
applying said second one-class ML model to a second set of transactions of a second inference data to identify whether each transaction is an anomaly or not;
receiving a second input data indicating whether each transaction identified as said anomaly is a fraud transaction or not; and
updating said second historical data by adding said second set of transactions and tagging each fraud transaction as being fraud.

18. The digital processing system of claim 15, wherein for said generating, said digital processing system performs the actions of:
training, based on said training data, a new one-class ML model;
applying said new one-class ML model to said test data, wherein said applying comprises providing said test data as input to said new one-class ML model and receiving as output a third set of transactions predicted as being anomalous by said new one-class ML model;
if said third set of transactions includes all of said first set of transactions:
selecting said new one-class ML model as said first one-class ML model; otherwise:
determining new values for one or more parameters provided as inputs for said training of said new one-class model; and
repeating said training and said applying with said one or more parameters set to said new values.

19. The digital processing system of claim 15, wherein for said forming, said digital processing system performs the actions of:
splitting said first historical data into said training data and said test data according to a ratio;
determining one or more transactions tagged as fraud in said training data; and
transferring said one or more transactions from said training data to said test data such that said training data is devoid of transactions tagged as fraud and said test data includes all transactions tagged as fraud.

20. The digital processing system of claim 19, wherein said digital processing system receives at said first time instance a third historical data and a training window,
said digital processing system further performing the actions of filtering the transactions contained in said third historical data based on said training window to obtain said first historical data.
